(19) United States
(12) Patent Application Publication
(10) Pub. No.: US 2024/0110127 A1
(43) Pub. Date: Apr. 4, 2024

(54) PLANAR WICK WITH ENGRAVED BOOSTER

(71) Applicant: LUMETIQUE, INC., Irvine, CA (US)

(72) Inventor: DayNa Decker, Irvine, CA (US)

(73) Assignee: LUMETIQUE, INC., Irvine, CA (US)

(21) Appl. No.: 17/955,682

(22) Filed: Sep. 29, 2022

(51) Int. Cl. C11C 5/00; C11C 5/02

(52) U.S. Cl. CPC C11C 5/006; C11C 5/02

(57) ABSTRACT

Wicks include a sheet, including wood, a wood-like substance, and/or a cellulose fiber, and an engraved booster region that is a region at a surface of the sheet where material of the sheet has been removed. Material may be removed by laser engraving. A ratio of the width of the engraved booster region to the width of the sheet may be 1:3 to 1:8. A width of the engraved booster region may be 0.075 to 0.175 inches. Methods for manufacturing wicks include laser engraving a planar workpiece to remove material from a surface of the workpiece forming engraved booster regions, and laser cutting the workpiece to form sheets including an engraved booster region.

### BACKGROUND OF THE DISCLOSURE

### Technical Field

The present disclosure relates to planar wicks with engraved boosters for use in candles and other lighting devices, candles and other lighting devices employing such wicks, and methods of preparing such wicks, candles, and other lighting devices.

### Description of the Related Art

The “background” description provided herein is for the purpose of generally presenting the context of the disclosure. Work of the presently named inventor, to the extent it is described in this background section, as well as aspects of the description which may not otherwise qualify as prior art at the time of filing, are neither expressly or impliedly admitted as prior art against the present disclosure.

A candle may include an ignitable wick embedded in wax or another flammable solid substance such as tallow that provides light, and in some cases, a fragrance. A candle may also be used to provide heat or keep time. A candle wick is typically made of braided cotton that holds the flame of the candle. A candle wick works by capillary action, conveying (or “wicking”) molten fuel to the flame. When a molten fuel such as melted wax reaches the flame, the fuel vaporizes and combusts. A candle wick influences how a candle burns. Important characteristics of a candle wick include diameter, stiffness, fire-resistance, and tethering.

Candles may present safety issues, particularly with respect to causing fires and burning users. In view of these issues, efforts have been made to test various aspects of the manner in which candles burn including, for example, stability, burn time, abnormalities, smoke/flaring, sputter, overflow, re-ignition, flame height, afterglow, external surface temperature (thermocouple), direct flame impingement, pool temperature, pool uniformity, pool diameter, carbon deposit, and soot emissions. These parameters contribute not only to the safety of a candle, but also to the performance and aesthetic characteristics of a candle.

Candle wicks have been woven or braided for well over the last century. Such conventional wicks may be woven from multiple fibers or filamentary yarns. The most commonly used yarn is cotton, although other natural fibers such as rayon, nylon, and hemp have also been used. Braided wicks may be produced in various sizes, shapes and constructions to achieve desired performance (flame height, wax pool size, self-trimming) and process (stability, self-supporting) requirements. The appropriate wick selection for a particular candle includes type of weave, core, size (diameter or width), and density of a wick. Even if wick selection is confined to braided wicks, there are many different types of braided wicks from which to choose.

More recent developments in candle design and manufacture involve the use of a planar wick in a candle. Such planar wicks may be made of wood, wood-like materials, semi-wood materials, cellulose materials, and other more rigid materials. Such planar wicks may provide improved capillary flow and increased functional surface area relative to prior braided wicks. As a result, such planar wicks can burn efficiently in a candle without producing undesirable smoke and carbon heading. Further, such planar wicks can create a stable and uniform wax pool diameter. By virtue of the materials and shapes of such planar wicks, the physical shape of a flame may be different than in candles using prior braided wicks. Also, such planar wicks offer decorative possibilities not available with prior braided wicks and may produce sound when burned—for example, a crackling sound like the sound of wood burning in a fireplace. Such planar wicks and candles employing them are described, for example, in U.S. Pat. Nos. 9,410,696, 9,261,275, D740,461, 9,039,409, 8,961,171, D705,459, D678,558, 8,348,662, D644,360, D644,359, D643,554, 2016/0298837, 2012/0225392, 2011/0027737, 2011/0027736, 2011/0027735, 2011/0024945, 2005/0037308, and 2004/0009447. The disclosures of each of the foregoing patents and patent application publications are incorporated herein by reference in their entireties.

A subsequent variation on such planar wicks is a wooden wick including a strip of wood, a booster member, which may also be made of wood, and a means for adhering the booster member to such strip of wood. Such planar wicks and candles employing them are described, for example, in U.S. Pat. Nos. 9,816,053, 9,796,946, 9,388,365, 9,120,995, D715,989, D708,777, 8,708,694, D669,615, D663,450, 2016/0281031, 2016/0272923, 2016/0272922, 2015/0322379, 2012/0064467, and 2008/0153046. The disclosures of each of the foregoing patents and patent application publications are incorporated herein by reference in their entireties.

A further variation on planar wicks is a planar wick including a planar body, wherein the wick is modified by cutting, engraving, printing, dyeing, etc., to achieve improvements in safety, performance, and aesthetic characteristics of the wick and a candle employing such wick. Such planar wicks and candles employing them are described, for example, in U.S. Pub. No. 2021/0033278. The disclosure of the foregoing patent application publication is incorporated herein by reference in its entirety.

While the foregoing planar wicks and subsequent variations represent a leap forward in design relative to the preceding braided wicks, there remains a need for improvements in safety and performance characteristics of candle wicks and candles employing such wicks.

In view of the foregoing, an object of the present disclosure is to provide planar wicks with engraved boosters for use in candles and other lighting devices, candles and other lighting devices employing such wicks, and methods of preparing such wicks, candles, and other lighting devices, with advantageous properties.

### BRIEF SUMMARY OF THE DISCLOSURE

The present disclosure is the result of the inventor's efforts to create a candle wick that has more consistent burn performance than known planar wicks and planar wicks with boosters.

A single-ply planar wick is typically a planar piece of wood, which may be provided in a range of thicknesses, lengths, and widths. Single-ply wicks are best suited for softer waxes, i.e., wax blends that have more paraffin, petrolatum, or coconut, and thus a low melting point.

A planar wick with a booster is typically a planar piece of wood, which may be provided in a range of thicknesses, lengths, and widths, with a smaller strip of wood glued thereon. A planar wick with a booster is more suitable for wax blends with higher contents of natural components such as soy, palm oil, stearic acid, beeswax, and pillar paraffin. Due to the presence of the smaller strip of wood, the wick produces extra heat, which is distributed around the diameter of a candle, resulting in a larger melt pool.

The present disclosure relates to a planar wick having an engraved booster. In embodiments, the wick is a planar strip of wood from which material has been removed by laser engraving. The region where material was removed—the engraved booster—has predetermined dimensions and is provided in a predetermined location on the planar strip of wood. In embodiments, the engraved booster is thinner than the planar strip of wood and extends along the length of one surface.

It was discovered that a wick having an engraved booster is suitable for a wide range of wax blends. Due to the channel or path along the surface of the wick, better absorption of fuel (liquid wax) is possible. In a single-ply planar wick, fuel must follow the natural channels of the wood, which is not necessarily the most efficient path to the top of a wick. Without being limited to a particular theory, it is believed that the engraved booster acts as a distribution canal that allows fuel to travel directly to the top edge of the wick. As a result, there is a constant flow of fuel to the location on the wick where combustion is taking place so there is a more stable flame height and, thus, a more stable burn rate. Further, there is less smoke/soot production. In embodiments, in which laser engraving is performed, it is possible that the laser drying the wood and the microscopic pattern of the engraving make even clearer pathways for fuel transmission.

The more efficient and stable combustion exhibited by planar wicks having engraved boosters according to the present disclosure results in enhance safety and performance when the wicks are used in candles.

According to a first aspect, the present disclosure relates to a wick, including: a sheet including at least one selected from the group consisting of a wood, a wood-like substance, and a cellulose fiber; and an engraved booster region that is a region at a surface of the sheet where material of the sheet has been removed. The sheet has a thickness, a height, and a width, the thickness being a smallest dimension of the sheet. The engraved booster region has a depth, a height, and a width, the depth being the smallest dimension of the engraved booster region. The height of the sheet and the height of the engraved booster region extend in a vertical direction when the wick is provided in a candle. The depth of the engraved booster region is a distance the engraved booster region extends into the thickness of the sheet, the depth of the engraved booster region being less than the thickness of the sheet. The height of the engraved booster region is a largest dimension of the engraved booster region. A ratio of the width of the engraved booster region to the width of the sheet is 1:3 to 1:8.

According to a second aspect, the present disclosure relates to a wick, including: a sheet including at least one selected from the group consisting of a wood, a wood-like substance, and a cellulose fiber; and an engraved booster region that is a region at a surface of the sheet where material of the sheet has been removed by laser engraving. The sheet has a thickness, a height, and a width, the thickness being a smallest dimension of the sheet. The engraved booster region has a depth, a height, and a width, the depth being the smallest dimension of the engraved booster region. The height of the sheet and the height of the engraved booster region extend in a vertical direction when the wick is provided in a candle. The depth of the engraved booster region is a distance the engraved booster region extends into the thickness of the sheet, the depth of the engraved booster region being less than the thickness of the sheet. The height of the engraved booster region is a largest dimension of the engraved booster region. The width of the engraved booster region is 0.075 to 0.175 inches.

According to a third aspect, the present disclosure relates to a method for manufacturing a plurality of wicks, each wick including a sheet and an engraved booster region where material of the sheet has been removed. The method includes: laser engraving a planar workpiece to remove material from a plurality of locations at a surface of the workpiece forming a plurality of engraved booster regions; and laser cutting the workpiece to form a plurality of sheets, each sheet comprising an engraved booster region. The workpiece includes at least one selected from the group consisting of a wood, a wood-like substance, and a cellulose fiber. Each of the plurality of sheets has a thickness, a height, and a width, the thickness being a smallest dimension of the sheet. Each of the engraved booster regions has a depth, a height, and a width, the depth being the smallest dimension of the engraved booster region. The height of each sheet and the height of each engraved booster region extend in a vertical direction when the wick is provided in a candle. The depth of each engraved booster region is a distance the engraved booster region extends into the thickness of the sheet, the depth of the engraved booster region being less than the thickness of the sheet comprising the engraved booster region. The height of the engraved booster region is a largest dimension of the engraved booster region. A ratio of the width of each engraved booster region to the width of each sheet is 1:3 to 1:8.

The foregoing paragraphs have been provided by way of general introduction and are not intended to limit the scope of the following claims.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1(a) is a perspective view of an embodiment of an exemplary planar wick with an engraved booster according to the present disclosure;

FIG. 1(b) is a front view of an embodiment of an exemplary planar wick with an engraved booster according to the present disclosure;

FIG. 1(c) is a top or bottom view of an embodiment of an exemplary planar wick with an engraved booster according to the present disclosure;

FIG. 2 is a schematic front view of an embodiment of an exemplary planar wick with an engraved booster according to the present invention provided in a disclosure with a magnified view of an edge of an engraved booster and a magnified view of spots forming the engraved booster;

FIG. 3(a) is a top view of an embodiment of an exemplary candle including a planar wick with an engraved booster according to the present disclosure;

FIG. 3(b) is a perspective view of an embodiment of an exemplary candle including a planar wick with an engraved booster according to the present disclosure; and

FIG. 4 is a photograph of an embodiment of an exemplary planar wick with an engraved booster according to the present disclosure.

### DETAILED DESCRIPTION OF THE EMBODIMENTS

Embodiments of the present disclosure will now be described more fully hereinafter with reference to the accompanying drawings, in which some, but not all of the embodiments of the disclosure are shown.

As used herein, the words “a” and “an” and the like carry the meaning of “one or more.” Additionally, within the description of this disclosure, where a numerical limit or range is stated, the endpoints are included unless stated otherwise. Also, all values and subranges within a numerical limit or range, including subranges excluding endpoints, are specifically included as if explicitly written out.

As used herein, the terms “optional” or “optionally” mean that the subsequently described event(s) can or cannot occur or the subsequently described component(s) may or may not be present (e.g., 0 wt %).

The term “comprising” is an open-ended term synonymous with terms such as including, containing, or having and is used herein to claim aspects of the invention which may include additional steps, components, functionality, and/or structure. The term “consisting essentially of” is used herein to claim aspects of the invention and additional unrecited steps or components that would not have a material effect on the basic and novel properties of a planar wick, candle, or other lighting device according to the present disclosure—as claimed or as obtained by a claimed process. Basic and novel properties of the present disclosure include the capability of a planar wick to produce a taller flame height, a hotter flame, a wider wax pool, and/or greater consistency in the foregoing properties from wick-to-wick, relative to known planar wicks. The term “consisting of” is used to claim aspects of the invention in which only those features explicitly recited in a claim are included and thus other steps or components not explicitly or inherently included in the claim are excluded.

The following discussion is made with reference to planar wicks with engraved boosters and candles including such wicks. However, the planar wicks with engraved boosters of the present application may also be used in other lighting devices, particularly in lanterns or lamps using a fuel that is liquid rather than solid at room temperature. In such embodiments, the composition and structure of the planar wicks with engraved boosters described below may be modified to ensure that a safe, sustained flame is obtained when the wick is lit.

In various exemplary embodiments, the present disclosure relates to planar wicks with engraved boosters for use in candles, candles employing such wicks, and methods of preparing such wicks and candles.

It is expressly intended that the features of the various wicks and candles described herein be interchangeably used and used in combination. That is, to the extent that a material, structure, and/or size is mentioned with respect to an embodiment, it is expressly intended that such parameter be suitably substituted for use in other embodiments. The present inventor has contemplated such combinations and intends that they be encompassed by this disclosure even if not written out.

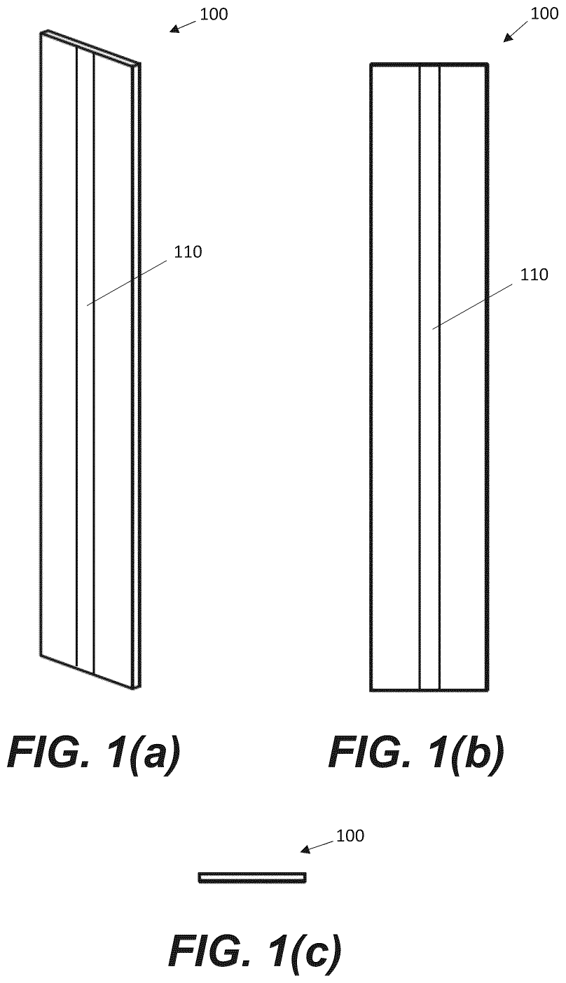

FIGS. 1(a), 1(b), and 1(c) are various views of an exemplary planar wick with an engraved booster according to the present disclosure. As shown in FIGS. 1(a), 1(b), and 1(c), a planar wick 100 has an engraved booster 110 formed on a surface thereof.

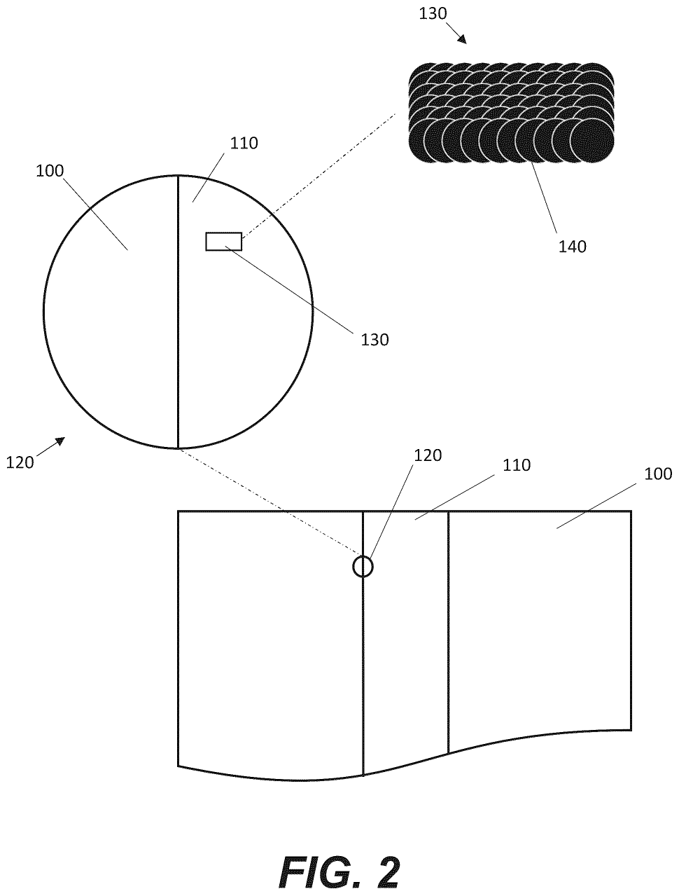

FIG. 2 shows, in a schematic view with magnified portions, closer detail of the planar wick 100 and engraved booster 110. A first magnified portion 120 in FIG. 2 depicts a margin of the engraved portion 110 (i.e., a border between a region where the engraved portion 110 is present and a region where the engraved portion 110 is not present on the planar wick 100). A second magnified portion 130 shows detail of the engraved portion 110, including spots 140 (e.g., spots formed by a laser) that collectively form the engraved portion.

In various exemplary embodiments, wicks according to the present disclosure include a sheet including at least one selected from the group consisting of a wood, a wood-like substance, and a cellulose fiber, and an engraved booster region that is a region at a surface of the sheet where material of the sheet has been removed. In embodiments, the sheet has a thickness, a height, and a width, the thickness being a smallest dimension of the sheet. In embodiments, the engraved booster region has a depth, a height, and a width, the depth being the smallest dimension of the engraved booster region. In embodiments, the height of the sheet and the height of the engraved booster region extend in a vertical direction when the wick is provided in a candle. In embodiments, the depth of the engraved booster region is a distance the engraved booster region extends into the thickness of the sheet, the depth of the engraved booster region being less than the thickness of the sheet. In embodiments, the height of the engraved booster region is a largest dimension of the engraved booster region.

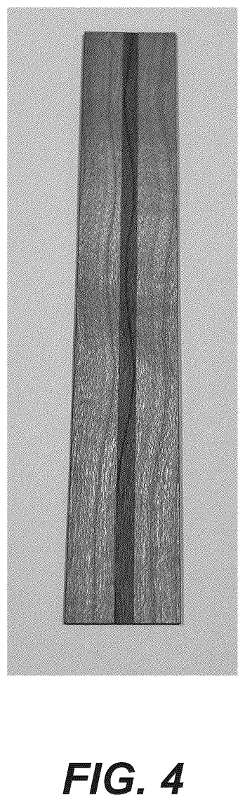

As noted above, an engraved booster region that is a region at a surface of the sheet where material of the sheet has been removed. While reference is made to removal, the engraved booster region could also constitute a region where material has been altered, e.g., by burning with a laser or chemical treatment. In the same manner that a trench or canal formed by removal of material, e.g., by engraving with a laser or pressing a blade or blades into a surface of the sheet, could form an engraved booster region, a trench or canal “filled” with altered material could also form an engraved booster region. In embodiments the engraved booster region is composed of plurality of spots (e.g., formed by a laser) where material been altered or removed (e.g., 125 to 1,000 DPI, or any subrange therein). The engraved booster region is typically rectangular in shape as shown in, e.g., FIGS. 1(b) and 4, and considerably narrower than the sheet but nearly identical in height. In embodiments, the height of the engraved booster region is slightly less than the height of the sheet, so that there are regions that are not engraved above and/or below the engraved booster region. As shown in FIG. 4, the engraved booster region may appear as a slightly darker shaded strip on the wick. In the case of a wood sheet as shown in FIG. 4, the grain of the wood may remain discernible in the area of the engraved booster region. When formed by laser engraving, the engraved booster region may, on a microscopic level, be composed of many spots or dots of removed or altered material, as shown in FIG. 2. The depth of the engraved booster region is less than the thickness of the sheet in which it is formed. In embodiments, the depth of the engraved booster region may be 0.0001 to 0.005 inches. The depth of the engraved booster region may be 0.0001, 0.0005, 0.001, 0.005, 0.01, or any subrange therein in ten-thousandths or thousandths of an inch. The depth may be substantially the same or constant throughout the engraved booster region or may vary by any range or subrange of depths set forth above.

In various exemplary embodiments, a ratio of the width of the engraved booster region to the width of the sheet is 1:3 to 1:8. The ratio of the width of the engraved booster region to the width of the sheet may be 1:3, 1:4, 1:5, 1:6, 1:7, 1:8, and all subranges therein. In further embodiments, the ratio of the width of the engraved booster region to the width of the sheet may encompass a broader range of ratios, e.g., 1:3 to 1:20, and all subranges therein.

In various exemplary embodiments, the width of the engraved booster region is 0.075 to 0.175 inches. The width of the engraved booster region is 0.075 inches, 0.1 inches, 0.125 inches, 0.15 inches, 0.175 inches, and all subranges in hundredths and thousandths of an inch therein. In further embodiments, the width of the engraved booster region may encompass a broader range of widths, e.g., 0.005 to 0.375 inches, and all subranges in hundredths and thousandths of an inch therein.

In various exemplary embodiments, the height of the engraved booster region is at least 80% of the height of the sheet. The engraved booster region may be 80%, 85%, 90%, 95%, 100%, and all subranges in percent therein.

In various exemplary embodiments, the engraved booster region is located in a middle third of the width of the sheet. In various exemplary embodiments, the wick comprises a single engraved booster region on a single side of the sheet.

It is preferred for a planar wick according to the present disclosure to have a single engraved booster region having a width of approximately 0.1 inches formed on a single surface of the wick. However, the present disclosure expressly encompasses alternate configurations, in which plural, separate engraved booster regions are formed on one or both sides of the sheet. For example, a planar wick may include plural engraved booster regions, each having a width and/or a ratio of the width of the engraved booster region to the width of the sheet, as described above. A planar wick could include one or two or three such engraved booster regions on one or both sides of the wick. While in, e.g., FIGS. 1(b) and 4, the engraved booster regions are rectangular and vertically arranged, it is possible that each engraved booster region could be composed of plural visibly distinct lines or spots or other shapes, which together form the engraved booster region. Also, the engraved booster regions or constituent lines thereof could be curved, zig-zagged, or wavy in appearance—however, in such cases the height dimension is usually the dominant or largest dimension of the engraved booster region.

Planar wicks described herein are intended to be used, e.g., in candles. When used in a candle, wicks are stood in a body of meltable fuel. Thus, wicks generally have a height dimension corresponding to the height dimension of a candle when the wick is in use. Likewise, wicks that are strictly or truly planar will have a width and a thickness that are perpendicular to the height, the thickness being the smallest dimension of the wick. Wicks that more generally planar (e.g., an “X” wick or a “+” wick) can be described by an overall greatest width in a direction perpendicular to the height and a thickness corresponding to the smallest dimension of the planar member that was bent, curved, or combined to obtain the wick.

Planar wicks described herein may have any suitable combination of dimensions and the dimensions of particular embodiments are selected to produce desired effects described herein in combination with particular materials and other structural parameters. Wicks may have a thickness of up to 0.005 inches, 0.005 inches, 0.010 inches, 0.015 inches, 0.020 inches, 0.025 inches, 0.030 inches, 0.035 inches, 0.040 inches, 0.045 inches, 0.050 inches, 0.060 inches, 0.070 inches, 0.080 inches, 0.090 inches, 0.1 inches, 0.11 inches, 0.12 inches, 0.125 inches, 0.125 inches or more, and all subranges in hundredths and thousandths of an inch therein. Preferably wicks have a thickness of 0.010 to 0.045 inches. Wicks may have a width of up to 0.0625 inches, 0.0625 inches, 0.125 inches, 0.25 inches, 0.375 inches, 0.5 inches, 1.0 inches, 1.5 inches, 2.0 inches, 2.5 inches, 3.0 inches, 3.5 inches, 4.0 inches, 4.5 inches, 5.0 inches, 5.5 inches, 6.0 inches, 6.5 inches, 7.0 inches, 7.5 inches, 8.0 inches, 8.5 inches, 9.0 inches, 9.0 inches or more, and all subranges in tenths of an inch therein. Preferably wicks have a width of 0.25 to 6 inches. Wicks may have a height of up to 1 inch, 1 inch, 2 inches, 3 inches, 4 inches, 5 inches, 6 inches, 7 inches, 8 inches, 9 inches, 10 inches, 10 inches or more, and all subranges in tenths of an inch therein. Preferably wicks have a height of 1 to 8 inches. Wick width and candle width may be described in ratios of their respective widths and ranges of ratios based on any of the width values described herein. Further, in embodiments, both wicks and candles will have variable widths. For example, both wick and candle may have widths that taper towards the top, taper towards the bottom, taper towards the middle, or taper at the top and the bottom. In preferred embodiments, the wick width varies with the candle width along the height dimension of the candle.

In embodiments, the material and dimensions of the planar wick are selected to promote a candle's functionality as well as a candle's contributions to ambiance. In embodiments, the wick is made of wood, semi-wood, or a wood-like material and, when lit, may provide a pleasant crackling sound and burns more thoroughly with less carbon heading and sooting than conventional wicks. Processed wood materials such as particleboard and fiberboard may also be used. Overall, woods having relatively straight, condensed grains and without checking make effective wicks. In contrast to traditional wicks, which require periodic trimming, maintenance of planar wicks can be performed with or without any tools. Rather, burned edges of planar wicks can be removed with the user's fingers before relighting. In various exemplary embodiments, such wicks are formed of single-ply, double-ply, multi-ply, multi-fibrous, colored, printed, die cut, and/or laser cut materials. Alternatively, or in addition, embedded minerals, oils, or oxidation enhancers may be used.

In embodiments, woods such as poplar, cherry, maple, wenge, oak, rosewood, and bamboo may be used as materials for preparing wicks. Preferably heartwood is used. Hard non-brittle, tight grain woods are preferred. Certain species may be preferable in particular applications because its higher moisture or oil content may influence characteristics of the flame and/or other properties such as production of a desirable crackling sound when burning. In addition to the preferred woods mentioned above, others such as walnut, ash, birch, pearwood, sapele, pommele, zebrawood, lacewood, mahogany, pine, teak, ebony, and various burls, may be used as wick materials. Woods having various moisture contents may be used. Particularly, woods having moisture contents of up to 1%, 1%, 2%, 3%, 4%, 5%, 6%, 7%, 8%, 9%, 10%, 11%, 12%, 13%, 14%, 15%, 16%, 17%, 18%, 19%, 20%, 20% more, and all subranges therein in tenths and hundredths of a percent, may be used to form wicks as described herein.

In various exemplary embodiments, the sheet comprises wood, and a grain direction of the wood is substantially aligned with the height of the sheet and/or the height of the engraved booster region.

Planar wicks including semi-wood or wood-like materials, either alone or in combination with wood, are particularly desirable. Layers or portions of wood may be combined, for example, with layers or portions of wood-like materials, semi-wood materials, cellulose, hemicellulose, lignin, cotton fiber, hemp fiber, coir, flax, and/or protein fibers. Alternatively, cellulose, hemicellulose, lignin, cotton fiber, hemp fiber, coir, flax, and/or protein fiber, can used to prepare wicks without the use of wood. Materials other than plain or pure wood, as described herein, may be used in any suitable format. For example, solid materials may be cut into sheets for further processing as described herein. As a further example, materials that are fibrous or particulate may be pressed into sheets for further processing as described herein with or without the use of adhesives or other matrix materials. Further, two, or three, or more sheets of material obtained as described herein or otherwise may be laminated together, e.g., using adhesives. Such laminates may include multiple layers of the same or different materials and layers having different dimensions.

Cotton or cotton-like materials, particularly, can be incorporated into a planar wick's construction. One example is to sandwich a piece of cotton between sheets of wood and seal the sandwiched construction with wax or an adhesive. Another example is to make a wood particle/powder fiberboard with small bits of cotton incorporated therein. A further example is to layer one or more layers of a cotton-like material to one or more layers of a wood-like material. The layers in such embodiments can be different or the same in width, height, and thickness.

While the wicks described herein are referred to as planar wicks, they need not be strictly or truly planar. Instead, it is expressly intended that the term planar—unless described as “strictly” or “truly” planar—includes bent or curved planar members or composites of multiple planar members. While a strictly or truly planar wick might have the shape of a straight line when viewed from above, a bent or curved planar wick might have the shape of a circle or an “S” when viewed from above. A wick including a composite of multiple planar members might have the shape an “X,” a “+,” or a cross from above. Thus, a planar wick as described herein may include bent, curved, or multiple, combined planar members that yield any alphanumeric or symbolic shape when viewed from above. Likewise, a sheet of material may be strictly or truly planar, bent or curved, or a composite of multiple sheets.

Planar wicks described herein and shown in figures attached hereto are generally planar or sheet-shaped or prepared from materials that planar or sheet-shaped. As described in further detail below, such materials maybe processed into precise shapes as described herein using techniques such as die cutting and laser cutting. Moreover, wicks can be cut through an entirety of their thickness or engraved through a portion of their thickness, e.g., by laser.

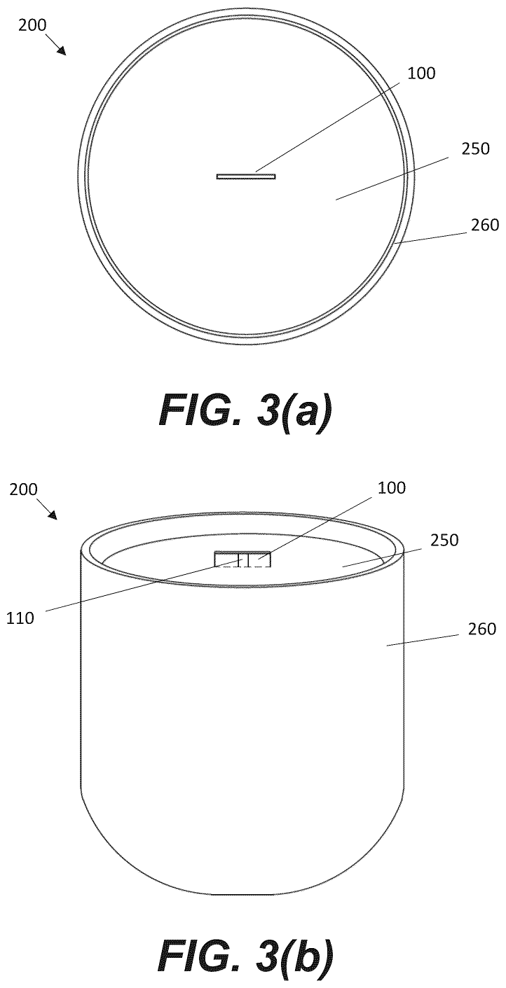

FIGS. 3(a) and 3(b) are two views of an exemplary candle including a planar wick with an engraved booster according to the present disclosure. The candle 200 includes a body of meltable fuel 250 provided in a container 260. The planar wick 100 including the engraved booster 110 is provided in the body of meltable fuel 255 such that a top portion of the wick 100 extends above a top surface of a meltable fuel 250 provided in the container 260.

In embodiments, a candle includes a body of meltable fuel and a planar wick. Meltable fuels are materials that are solid at room temperature and provide light when vaporized and ignited (i.e., when conveyed via a lit wick embedded in a body of the meltable fuel). Exemplary meltable fuels include fusible, flammable solid waxes and wax-like materials such as, for example, petroleum (paraffin) wax, mineral (montan) wax, synthetic wax (polyethylene or Fischer Tropsch), natural waxes (vegetable or animal—e.g., beeswax, carnauba, candelilla, soy, coconut, palm, apricot), microcrystalline waxes, polymers, polyolesters, clear candle waxes or gels (ester-terminated polyamides (ETPA) or ETPA-based materials), and other fuels known to skilled artisans. A single meltable fuel or blends of meltable fuels may be used. In particularly preferred embodiments, one or more of a paraffin/petrolatum wax blend, a soy/paraffin/petrolatum wax blend, and a pure soy wax may be used as a meltable fuel.

In embodiments, meltable fuels may be modified with additives to alter the hardness, color, burn rate, and/or aroma of the meltable fuel. Exemplary additives include stearic acid, UV inhibitors, polyethylene, scent oils, and colorants, such as pigments and/or dyes.

In embodiments, a candle includes a free-standing body of meltable fuel. The shape of the free-standing body of meltable fuel is not particularly limited—any shape that can be suitably molded would be acceptable.

In alternative embodiments, a candle includes a meltable fuel held in a container. There is no particular limitation on the size or shape of the container or the material from which the container is made. In embodiments, the container is made of glass, ceramic, metal, concrete, or plastic. The glass, ceramic, metal, concrete, or plastic may be natural, clear, or colored. In embodiments, the container is a resealable jar. In embodiments, the container is in the shape of a cylinder or prism open at a top end. The cylinder may be a right, oblique, or irregular cylinder having a circular, oval, or other cross-section. The prism may be a right, oblique, or irregular prism having a triangular, square, rectangular, or other polygonal cross-section.

Whether provided as freestanding bodies of meltable fuel or in containers, candles generally can be defined in terms of their width and height as configured when in use. Candles as described herein may have a width of up to 1 inch, 1 inch, 2 inches, 3 inches, 4 inches, 5 inches, 6 inches, 7 inches, 8 inches, 9 inches, 10 inches, 10 inches or more, and all subranges in tenths and hundredths of an inch therein. Preferably candles have a width of 1 to 10 inches. Candles may have a height of up to 2 inches, 2 inches, 3 inches, 4 inches, 5 inches, 6 inches, 7 inches, 8 inches, 9 inches, 10 inches, 10 inches or more, and all subranges in tenths and hundredths of an inch therein. Preferably candles have a height of 2 to 10 inches.

When lit, candles will create wax pools that vary in size based on the wax type and the wick type and configuration. In preferred embodiments, the wax should liquefy to the outer portion of the candle and the flame height should be between 0.05 and 3.0 inches in height, including all subranges in tenths and hundredths of an inch therein.

In embodiments, candles can be made using containers or molds. In embodiments, a planar wick is positioned in a container or mold and a melted meltable fuel is added thereto. The wick can be positioned with or without a sustainer. A sustainer will include a flat surface or multiple points of contact on its bottom to stably hold a wick upright in the absence of meltable fuel and/or while melted fuel is poured around the wick. A sustainer will further include structure for holding a wick upright. For example, twin upright structures for grasping a generally planar or sheet like wick or a cup-like structure for holding a substantially cylindrical wick. In alternative embodiments the melted fuel can be added to the mold or container before positioning the wick.

In various exemplary embodiments, the present disclosure relates to a method for manufacturing a plurality of wicks, each wick including a sheet and an engraved booster region where material of the sheet has been removed. The method includes: laser engraving a planar workpiece to remove material from a plurality of locations at a surface of the workpiece forming a plurality of engraved booster regions; and laser cutting the workpiece to form a plurality of sheets, each sheet comprising an engraved booster region. The wick and engraved booster of each wick may be formed of any material and to have any dimension or combination thereof described above.

The laser engraving and laser cutting of the methods described herein are performed using a laser machine. The type and manufacturer of laser machine are not particularly limited so long as the laser machine is capable of: (i) engraving veneer according to a precise pattern to remove or alter some material at a surface of the veneer to form engraved boosters as described herein; and (ii) cutting the veneer according to a precise pattern to form planar wicks as described herein. Conceivably, these two functions could be performed using different machines. However, most commercially available laser machines can perform both functions.

In embodiments, cutting can be performed before engraving. However, as a practical matter, it is simpler to perform engraving on a large piece of veneer and subsequently cut wicks from the veneer to include the already-engraved boosters, rather than handling and engraving many much smaller wicks.

As noted above, any suitable laser machine may be used. Exemplary laser types are CO₂ lasers (gas lasers), fiber lasers, and Nd:YAG, Nd:YVO (crystal lasers), however CO₂ lasers are preferred.

Suitable lasers are typically computer controlled, permitting precise control of the geometry of engraving and cuttings. Each laser machine will have its own settings which may be controlled to form planar wicks with engraved boosters as described herein. Exemplary settings include resolution, power, speed, and frequency. Other optional features and settings may be employed to achieve the wick geometries and features described herein.

In various exemplary embodiments, the workpiece is a sheet of wood, i.e., wood veneer. The sheet of wick material may desirably have a thickness of 0.010 to 0.06 inches (i.e., any wick thickness described herein). Preferably, the wood is a hardwood having substantially straight grains. Even more preferably, the wood is cherry, maple, or poplar.

In embodiments, the workpiece may be dried before or after laser engraving and/or laser cutting are carried out. The manner of drying is not particularly limited.

In embodiments, the workpiece may be dyed before or after laser engraving and/or laser cutting are carried out. The manner of coloring is not particularly limited. For example, the workpiece (or wick product) may be dyed in any manner described in U.S. Provisional Application No. 63/281,797, filed Nov. 22, 2021, the disclosure of which is incorporated herein by reference in its entirely. In embodiments, the workpiece is dyed in its entirely in a single color before laser engraving and laser cutting are performed. In alternative embodiments, wicks obtained by methods described herein are batch dyed.

In various exemplary embodiments, laser engraving the workpiece further includes engraving ornamental images (e.g., alphanumeric or symbolic shapes) onto a surface of the workpiece.

Processes for preparing a planar wick according to the present disclosure, further include applying a bend or curve to the wick after cutting. In embodiments, the bent or curved wick has an S-shape, or other alphanumeric or symbolic shape when viewed from above. In embodiments, plural wicks may be cut and/or fitted together, e.g., to form a +, X, or cross when viewed from above.

In various exemplary embodiments, the present disclosure is directed the following items and all combinations thereof:

1. A wick, comprising:
a sheet comprising at least one selected from the group consisting of a wood, a wood-like substance, and a cellulose fiber; and
an engraved booster region that is a region at a surface of the sheet where material of the sheet has been removed;
wherein:
the sheet has a thickness, a height, and a width, the thickness being a smallest dimension of the sheet;
the engraved booster region has a depth, a height, and a width, the depth being the smallest dimension of the engraved booster region;
the height of the sheet and the height of the engraved booster region extend in a vertical direction when the wick is provided in a candle;
the depth of the engraved booster region is a distance the engraved booster region extends into the thickness of the sheet, the depth of the engraved booster region being less than the thickness of the sheet;
the height of the engraved booster region is a largest dimension of the engraved booster region; and
a ratio of the width of the engraved booster region to the width of the sheet is 1:3 to 1:8.

2. The wick of item 1 or any item depending therefrom, wherein the height of the engraved booster region is at least 80% of the height of the sheet.

3. The wick of item 1 or any item depending therefrom, wherein engraved booster region is located in a middle third of the width of the sheet.

4. The wick of item 1 or any item depending therefrom, wherein the wick comprises a single engraved booster region on a single side of the sheet.

5. The wick of item 1 or any item depending therefrom, wherein the wick comprises plural, separate engraved booster regions formed on one or both sides of the sheet.

6. The wick of item 1 or any item depending therefrom, wherein the engraved booster region is formed by laser engraving the sheet.

7. The wick of item 1 or any item depending therefrom, wherein the engraved booster region comprises a plurality of spots where material of the sheet has been removed.

8. The wick of item 1 or any item depending therefrom, wherein:
the height of the sheet is 1 to 8 inches;
the width of the sheet is 0.125 to 6 inches;
the thickness of the sheet is 0.010 to 0.045 inches; and
the width of the engraved booster region is 0.05 to 0.25 inches.

9. The wick of item 1 or any item depending therefrom, wherein the sheet comprises cherry wood.

10. The wick of item 1 or any item depending therefrom, wherein the sheet comprises maple wood.

11. The wick of item 1 or any item depending therefrom, wherein the sheet comprises poplar wood.

12. The wick of item 1 or any item depending therefrom, wherein the sheet comprises wood that has been dyed.

13. The wick of item 1 or any item depending therefrom, wherein:
the sheet comprises wood;
a grain direction of the wood is substantially aligned with the height of the sheet.

14. A candle, comprising:
the wick of item 1 or any item depending therefrom; and
a body of meltable fuel.

15. The candle of item 14 or any item depending therefrom, wherein the wick is held upright in the body of meltable fuel by a sustainer.

16. The candle of item 14 or any item depending therefrom, wherein the meltable fuel comprises a natural wax.

17. The candle of item 14 or any item depending therefrom, wherein the meltable fuel comprises a petroleum-based wax.

18. The candle of item 14 or any item depending therefrom, wherein the meltable fuel comprises a blend of natural and petroleum-based waxes.

19. The candle of item 14 or any item depending therefrom, wherein the body of meltable fuel is provided in a container.

20. A wick, comprising:
a sheet comprising at least one selected from the group consisting of a wood, a wood-like substance, and a cellulose fiber; and
an engraved booster region that is a region at a surface of the sheet where material of the sheet has been removed by laser engraving;
wherein:
the sheet has a thickness, a height, and a width, the thickness being a smallest dimension of the sheet;
the engraved booster region has a depth, a height, and a width, the depth being the smallest dimension of the engraved booster region;
the height of the sheet and the height of the engraved booster region extend in a vertical direction when the wick is provided in a candle;
the depth of the engraved booster region is a distance the engraved booster region extends into the thickness of the sheet, the depth of the engraved booster region being less than the thickness of the sheet;
the height of the engraved booster region is a largest dimension of the engraved booster region; and
the width of the engraved booster region is 0.075 to 0.175 inches.

21. The wick of item 20 or any item depending therefrom, wherein the height of the engraved booster region is at least 80% of the height of the sheet.

22. The wick of item 20 or any item depending therefrom, wherein engraved booster region is located in a middle third of the width of the sheet.

23. The wick of item 20 or any item depending therefrom, wherein the wick comprises a single engraved booster region on a single side of the sheet.

24. The wick of item 20 or any item depending therefrom, wherein the wick comprises plural, separate engraved booster regions formed on one or both sides of the sheet.

25. The wick of item 20 or any item depending therefrom, wherein the sheet comprises cherry wood.

26. The wick of item 20 or any item depending therefrom, wherein the sheet comprises maple wood.

27. The wick of item 20 or any item depending therefrom, wherein the sheet comprises poplar wood.

28. The wick of item 20 or any item depending therefrom, wherein the sheet comprises wood that has been dyed.

29. The wick of item 20 or any item depending therefrom, wherein:
the sheet comprises wood;
a grain direction of the wood is substantially aligned with the height of the sheet.

30. A candle, comprising:
the wick of item 20 or any item depending therefrom; and
a body of meltable fuel.

31. The candle of item 30 or any item depending therefrom, wherein the wick is held upright in the body of meltable fuel by a sustainer.

32. The candle of item 30 or any item depending therefrom, wherein the meltable fuel comprises a natural wax.

33. The candle of item 30 or any item depending therefrom, wherein the meltable fuel comprises a petroleum-based wax.

34. The candle of item 30 or any item depending therefrom, wherein the meltable fuel comprises a blend of natural and petroleum-based waxes.

35. A method for manufacturing a plurality of wicks, each wick comprising a sheet and an engraved booster region where material of the sheet has been removed, the method comprising:
laser engraving a planar workpiece to remove material from a plurality of locations at a surface of the workpiece forming a plurality of engraved booster regions; and
laser cutting the workpiece to form a plurality of sheets, each sheet comprising an engraved booster region;
wherein:
the workpiece comprises at least one selected from the group consisting of a wood, a wood-like substance, and a cellulose fiber;
each of the plurality of sheets has a thickness, a height, and a width, the thickness being a smallest dimension of the sheet;
each of the engraved booster regions has a depth, a height, and a width, the depth being the smallest dimension of the engraved booster region;
the height of each sheet and the height of each engraved booster region extend in a vertical direction when the wick is provided in a candle;
the depth of each engraved booster region is a distance the engraved booster region extends into the thickness of the sheet, the depth of the engraved booster region being less than the thickness of the sheet comprising the engraved booster region;
the height of the engraved booster region is a largest dimension of the engraved booster region; and
a ratio of the width of each engraved booster region to the width of each sheet is 1:3 to 1:8.

36. The method of item 35 or any item depending therefrom, wherein the height of each engraved booster region is at least 80% of the height of the sheet having the engraved booster region.

37. The method of item 35 or any item depending therefrom, wherein each engraved booster region is located in a middle third of the width of the sheet having the engraved booster region.

38. The method of item 35 or any item depending therefrom, wherein each wick comprises a single engraved booster region on a single side of the sheet having the engraved booster region.

39. The method of item 35 or any item depending therefrom, wherein each wick comprises plural, separate engraved booster regions formed on one or both sides of the sheet.

40. The method of item 35 or any item depending therefrom, wherein:
the height of each sheet is 1 to 8 inches;
the width of each sheet is 0.125 to 6 inches;
the thickness of each sheet is 0.010 to 0.045 inches; and
the width of each engraved booster region is 0.05 to 0.25 inches.

41. The method of item 35 or any item depending therefrom, wherein the workpiece comprises cherry wood.

42. The method of item 35 or any item depending therefrom, wherein the workpiece comprises maple wood.

43. The method of item 35 or any item depending therefrom, wherein the workpiece comprises poplar wood.

44. The method of item 35 or any item depending therefrom, wherein the workpiece comprises wood that has been dyed.

45. The method of item 35 or any item depending therefrom, wherein:
the workpiece comprises wood;
laser cutting the workpiece comprises forming each sheet so that a grain direction of the wood is substantially aligned with the height of the sheet.

46. The method of item 35 or any item depending therefrom, wherein:
laser engraving comprises laser engraving with a CO₂ laser; and
laser cutting comprises laser cutting with a CO₂ laser.

### EXAMPLES

### Production Example 1

Planar wicks with engraved boosters were prepared by laser cutting and engraving a sheet of cherry wood veneer having a thickness of 0.03 inches using a laser machine. Prior to laser cutting, engraved boosters were formed on the veneer so that each wick would have an engraved booster located centrally on one surface of the wick. Each engraved booster was formed in a rectangular shape having a height of slightly less than 2.75 inches and a width of 0.1 inches, with the length and width of the engraved booster being aligned with the length and width of a respective wick. FIG. 4 is a photograph of a planar wick with an engraved booster as prepared.

### Production Example 1A

Planar wicks with boosters were prepared by laser cutting a sheet of cherry wood veneer having a thickness of 0.03 inches and a sheet of cherry veneer having a thickness of 0.02 inches using a laser machine. The wicks were laser cut from the 0.03-inch veneer into rectangles having a height of 2.75 inches and a width of 0.5 inches. The boosters were cut from the 0.02-inch veneer into rectangles having a height of 2.75 inches and a width of 0.2 inches. Each booster was applied to a corresponding wick with an adhesive so that each wick had a booster located centrally on one surface of the wick, with the length and width of the booster being aligned with the length and width of the respective wick.

### Production Example 1B

Planar wicks were prepared by laser cutting a sheet of cherry wood veneer having a thickness of 0.03 inches using a laser machine. The wicks were laser cut from the veneer into rectangles having a height of 2.75 inches and a width of 0.5 inches.

### Example 1

Three candles (Samples 1, 2, and 3) were assembled in containers using planar wicks with engraved boosters of Production Example 1 as wicks and virgin coconut soy wax as the meltable fuel. The performance of the wicks was evaluated using the Candle Data Acquisition System (CDAS). The candles were burned and flame height was measured continuously until each candle self-extinguished. The average flame height and standard deviation of flame height over the life of the candle were measured. In this testing, a flame height range of 0.5 to 0.75 inches is considered ideal and safe. In addition, a plot of flame height over time and video showing the flame over the life of the candle were observed. The results for average flame height and standard deviation of flame height are shown in TABLE 1 below.

### Comparative Example 1A

Three candles (Samples 1, 2, and 3) were assembled as described with respect to Example 1, except that planar wicks with boosters of Production Example 1A were used as wicks.

### Comparative Example 1B

Three candles (Samples 1, 2, and 3) were assembled as described with respect to Example 1, except that planar wicks of Production Example 1C were used as wicks.

### Example 2

Three candles (Samples 1, 2, and 3) were assembled as described with respect to Example 1, except that a soy blend wax was used as the meltable fuel.

### Comparative Example 2A

Three candles (Samples 1, 2, and 3) were assembled as described with respect to Example 2, except that planar wicks with boosters of Production Example 1A were used as wicks.

### Comparative Example 2B3

Three candles (Samples 1, 2, and 3) were assembled as described with respect to Example 2, except that planar wicks of Production Example 1 were used as wicks.

TABLE 1
(all flame heights in inches)

| | Example | | | | | |
|---|---|---|---|---|---|---|
| | | Comp. | Comp. | | Comp. | Comp. |
| | Ex. 1 | Ex. 1A | Ex. 1B | Ex. 2 | Ex. 2A | Ex. 2B |
| Wick | Prod. Ex. 1 | Prod. Ex. 1A | Prod. Ex. 1B | Prod. Ex. 1 | Prod. Ex. 1A | Prod. Ex. 1B |
| Meltable | Virgin | Virgin | Virgin | Soy Blend | Soy Blend | Soy Blend |
| Fuel | Coconut | Coconut | Coconut | | | |
| | Soy | Soy | Soy | | | |
| Samp. 1 | 0.67 | 1.21 | 0.76 | 0.69 | 1.03 | 0.65 |
| Average | | | | | | |
| Flame | | | | | | |
| Height | | | | | | |
| Samp. 1 | 0.15 | 0.28 | 0.21 | 0.18 | 0.31 | 0.18 |
| Standard | | | | | | |
| Deviation | | | | | | |
| Flame | | | | | | |
| Height | | | | | | |
| Samp. 2 | 0.77 | 0.93 | 0.73 | 0.73 | 1.07 | 0.7 |
| Average | | | | | | |
| Flame | | | | | | |
| Height | | | | | | |
| Samp. 2 | 0.21 | 0.22 | 0.16 | 0.22 | 0.32 | 0.24 |
| Standard | | | | | | |
| Deviation | | | | | | |
| Flame | | | | | | |
| Height | | | | | | |
| Samp. 3 | 0.66 | 0.83 | 0.66 | 0.66 | 0.92 | 0.99 |
| Average | | | | | | |
| Flame | | | | | | |
| Height | | | | | | |
| Samp 3 | 0.15 | 0.19 | 0.16 | 0.15 | 0.26 | 0.23 |
| Standard | | | | | | |
| Deviation | | | | | | |
| Flame | | | | | | |
| Height | | | | | | |
| Average | 0.70 | 0.99 | 0.72 | 0.69 | 1.01 | 0.78 |
| Flame | | | | | | |
| Height | | | | | | |
| (All | | | | | | |
| Samples) | | | | | | |
| Standard | 0.17 | 0.23 | 0.18 | 0.18 | 0.30 | 0.22 |
| Deviation | | | | | | |
| Flame | | | | | | |
| Height | | | | | | |
| (All | | | | | | |
| Samples) | | | | | | |

As shown in TABLE 1 above, when using either virgin coconut soy wax or a soy wax blend as the meltable fuel, the planar wicks with engraved boosters exhibited a lower standard deviation of flame height than the planar wicks with boosters and the planar wicks. Further, in addition to being consistent in flame height, the average flame height for the planar wicks with engraved boosters was desirably around 0.75 inches. Viewing the plot of flame height over time, the planar wicks with engraved boosters exhibited the least variation over the life of a candle and contained the lowest maximum flame heights relative to the planar wicks with boosters and the planar wicks. Viewing the video results, the planar wicks with engraved boosters exhibited the least flame height variation and the maximum flame heights were generally at safe levels.

The planar wicks with boosters, when used with the virgin coconut wax or the soy wax blend yielded the highest flame heights and the largest standard deviation of flame height. Viewing the plot of flame height over time, the planar wicks with boosters showed the largest flame heights (over 1.6 inches) and greatest variation (as low as 0.3 inches). Viewing the video results, the planar wicks with boosters appeared showed sustained high flame heights.

The planar wicks, although exhibiting relatively good average flame heights when used with the virgin coconut wax or the soy wax blend, yielded some very low flame heights early in the burn cycle when used with virgin coconut and very high flame heights when used with the soy blend.

The planar wicks with engraved boosters exhibited a more consistent, safe flame than the planar wicks with boosters and the planar wicks. This was true even when the meltable fuel was varied.

### Production Example 2

Planar wicks with engraved boosters were prepared by laser cutting and engraving a sheet of cherry wood veneer having a thickness of 0.03 inches using a laser machine. The wicks were laser cut from the veneer into rectangles having a height of 2.75 inches and a width of 0.375 inches. Prior to laser cutting, engraved boosters were formed on the veneer so that each wick would have an engraved booster located centrally on one surface of the wick. Each engraved booster was formed in a rectangular shape having a height of slightly less than 2.75 inches and a width of 0.1 inches, with the length and width of the engraved booster being aligned with the length and width of a respective wick.

### Production Example 3

Planar wicks with engraved boosters were prepared as described above with respect to Production Example 2, except the wicks were laser cut from the veneer into rectangles having a height of 2.75 inches and a width of 0.625 inches.

### Production Example 4

Planar wicks with engraved boosters were prepared as described above with respect to Production Example 2, except cherry veneer having a thickness of 0.4 inches was used, and the wicks were laser cut from the veneer into rectangles having a height of 2.75 inches and a width of 0.7 inches.

### Example 3

Six candles (Samples 1 to 6) were assembled in containers using planar wicks with engraved boosters of Production Example 2 as wicks and a paraffin/petrolatum wax blend as the meltable fuel. The containers were cylindrical, tin containers having a diameter of 2.5 inches. In Samples 4 to 6, fragrance was added to the meltable fuel. The candles were observed over seven burn cycles alternating between four and two hours in length, and the average flame height was measured for each burn cycle. In this testing, a flame height of under 1 inch is understood to be safe, and 0.5 inches is understood to be ideal. The results for average flame height and standard deviation of flame height are shown in TABLE 2 below.

### Example 4

Six candles (Samples 1 to 6) were assembled in containers using planar wicks with engraved boosters of Production Example 3 as wicks and a soy/paraffin/petrolatum wax blend as the meltable fuel. The containers were cylindrical, glass containers having a diameter of 3.4 inches. In Samples 4 to 6, fragrance was added to the meltable fuel. The candles were observed over seven burn cycles alternating between four and two hours in length, and the average flame height was measured for each burn cycle. The results for average flame height and standard deviation of flame height are shown in TABLE 2 below.

### Example 5

Six candles (Samples 1 to 6) were assembled in containers using planar wicks with engraved boosters of Production Example 4 as wicks and a natural (soy) wax as the meltable fuel. The containers were cylindrical, glass containers having a diameter of 3 inches. The candles were observed over six burn cycles alternating between two and four hours in length, and the average flame height was measured for each burn cycle. The results for average flame height and standard deviation of flame height are shown in TABLE 2 below.

TABLE 2
(all flame heights in inches)

| Example | Example 2 | Example 3 | Example 4 |
|---|---|---|---|
| Wick | Prod. Ex. 2 | Prod. Ex. 3 | Prod. Ex. 4 |
| Wick Width | 0.375 inches | 0.625 inches | 0.7 inches |
| Wick Thickness | 0.03 inches | 0.03 inches | 0.04 inches |
| Meltable Fuel | Paraffin/ | Soy/Paraffin/ | Natural (Soy) |
| | Petrolatum | Petrolatum Wax | Wax |
| | Wax Blend | Blend | |
| Samp. 1 | 0.46 | 0.54 | 0.26 |
| Average Flame | | | |
| Height | | | |
| Samp. 2 | 0.51 | 0.56 | 0.30 |
| Average Flame | | | |
| Height | | | |
| Samp. 3 | 0.51 | 0.59 | 0.26 |
| Average Flame | | | |
| Height | | | |
| Samp. 4 | 0.43 | 0.46 | 0.36 |
| Average Flame | | | |
| Height | | | |
| Samp. 5 | 0.55 | 0.51 | 0.28 |
| Average Flame | | | |
| Height | | | |
| Samp. 6 | 0.56 | 0.54 | 0.34 |
| Average Flame | | | |
| Height | | | |
| Average Flame | 0.514 | 0.532 | 0.319 |
| Height (Average of | | | |
| Averages Per Burn | | | |
| Cycle) | | | |
| Standard Deviation | 0.053 | 0.057 | 0.056 |
| Flame Height | | | |

As shown in TABLE 2 above, the planar wicks with engraved boosters made from cherry wood having a thickness of 0.03 inches and a width of 0.375 inches performed well in a paraffin/petrolatum wax blend. The flame heights averaged between 0.5 in to 0.55 inches with a very low standard deviation. When observed during burning, the planar wicks with engraved boosters provided a consistently healthy flame.

Planar wicks with engraved boosters made from cherry wood having a thickness of 0.03 inches and a width of 0.625 inches (wider) performed well in a paraffin/petrolatum wax blend. Flame heights averaged at about 0.53 inches with a low standard deviation. When observed during burning, the planar wicks with engraved boosters provided a consistently healthy flame.

Planar wicks with engraved boosters made from cherry wood having a thickness of 0.04 inches (thicker) and a width of 0.7 inches (still wider) performed well in a paraffin/petrolatum wax blend. When observed during burning, the planar wicks with engraved boosters again provided a consistently healthy flame.

The results in TABLE 2 show that the improvement in performance of the planar wicks with engraved boosters exhibited relative to the planar wicks with boosters and the planar wicks as shown in TABLE 1 can be sustained, even if the wick geometry (especially width and thickness) are varied and different meltable fuels are used. Thus, the planar wicks with engraved boosters can be readily used most candles waxes in broad use. Without being limited to a particular theory, it is believed that the engraving helps normalize variations or anomalies in wood that may inhibit or exaggerate the flow of fuel causing variations in the flame height. When fuel flow is inhibited, flames are low and when fuel flow is exaggerated, flames can be dangerously high in a burn cycle. The planar wicks with engraved boosters of the present disclosure exhibit consisting flame height throughout a candle's life.

The foregoing discussion discloses and describes merely exemplary embodiments of the present disclosure. As will be understood by those skilled in the art, the present disclosure may be embodied in other specific forms without departing from the spirit or essential characteristics thereof. Accordingly, the disclosure of the present invention is intended to be illustrative, but not limiting of the scope of the disclosure, as well as other claims. The disclosure, including any readily discernible variants of the teachings herein, defines, in part, the scope of the foregoing claim terminology such that no inventive subject matter is dedicated to the public.

1. A wick, comprising:
a sheet comprising at least one selected from the group consisting of a wood, a wood-like substance, and a cellulose fiber; and
an engraved booster region that is a region at a surface of the sheet where material of the sheet has been removed;
wherein:
the sheet has a thickness, a height, and a width, the thickness being a smallest dimension of the sheet;
the engraved booster region has a depth, a height, and a width, the depth being the smallest dimension of the engraved booster region;
the height of the sheet and the height of the engraved booster region extend in a vertical direction when the wick is provided in a candle;
the depth of the engraved booster region is a distance the engraved booster region extends into the thickness of the sheet, the depth of the engraved booster region being less than the thickness of the sheet;
the height of the engraved booster region is a largest dimension of the engraved booster region; and
a ratio of the width of the engraved booster region to the width of the sheet is 1:3 to 1:8.

2. The wick of claim 1, wherein the height of the engraved booster region is at least 80% of the height of the sheet.

3. The wick of claim 1, wherein engraved booster region is located in a middle third of the width of the sheet.

4. The wick of claim 1, wherein the wick comprises a single engraved booster region on a single side of the sheet.

5. The wick of claim 1, wherein the wick comprises plural, separate engraved booster regions formed on one or both sides of the sheet.

6. The wick of claim 1, wherein the engraved booster region is formed by laser engraving the sheet.

7. The wick of claim 1, wherein the engraved booster region comprises a plurality of spots where material of the sheet has been removed.

8. The wick of claim 1, wherein:
the height of the sheet is 1 to 8 inches;
the width of the sheet is 0.125 to 6 inches;
the thickness of the sheet is 0.010 to 0.045 inches; and
the width of the engraved booster region is 0.05 to 0.25 inches.

9. The wick of claim 1, wherein the sheet comprises cherry wood.

10. The wick of claim 1, wherein the sheet comprises maple wood.

11. The wick of claim 1, wherein the sheet comprises poplar wood.

12. The wick of claim 1, wherein the sheet comprises wood that has been dyed.

13. The wick of claim 1, wherein:
the sheet comprises wood;
a grain direction of the wood is substantially aligned with the height of the sheet.

14. A candle, comprising:
the wick of claim 1; and
a body of meltable fuel.

15. The candle of claim 14, wherein the wick is held upright in the body of meltable fuel by a sustainer.

16. The candle of claim 14, wherein the meltable fuel comprises a natural wax.

17. The candle of claim 14, wherein the meltable fuel comprises a petroleum-based wax.

18. The candle of claim 14, wherein the meltable fuel comprises a blend of natural and petroleum-based waxes.

19. The candle of claim 14, wherein the body of meltable fuel is provided in a container.

20. A wick, comprising:
a sheet comprising at least one selected from the group consisting of a wood, a wood-like substance, and a cellulose fiber; and
an engraved booster region that is a region at a surface of the sheet where material of the sheet has been removed by laser engraving;
wherein:
the sheet has a thickness, a height, and a width, the thickness being a smallest dimension of the sheet;
the engraved booster region has a depth, a height, and a width, the depth being the smallest dimension of the engraved booster region;
the height of the sheet and the height of the engraved booster region extend in a vertical direction when the wick is provided in a candle;
the depth of the engraved booster region is a distance the engraved booster region extends into the thickness of the sheet, the depth of the engraved booster region being less than the thickness of the sheet;
the height of the engraved booster region is a largest dimension of the engraved booster region; and
the width of the engraved booster region is 0.075 to 0.175 inches.
